(19) United States
(12) Patent Application Publication
(10) Pub. No.: US 2007/0067160 A1
(43) Pub. Date: Mar. 22, 2007

(54) Microphone with projector controller

(76) Inventor: Pin-Che Chen, Taipei City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/228,242

(22) Filed: Sep. 19, 2005

(51) Int. Cl. G10L 11/00

(52) U.S. Cl. 704/200

(57) ABSTRACT

A microphone with projector controller (working with a receiving device) is disclosed. The microphone of the present invention comprises a body, a processing unit, a sound collecting device, an analog-to-digital converter, a control unit and a transmitter. The processing unit is disposed inside the body. The sound collecting device is disposed at an appropriate location on the body so as to collect audio signals, which may then be converted to digital signals; the sound collecting device is connected with the processing unit. The analog-to-digital converter is disposed inside the body and connected with the processing unit so as to convert the signals sent to the processing unit. The control unit is disposed at an appropriate location on the body and is connected with the processing unit. The transmitter is connected with the processing unit. The audio signals collected by the sound collecting device and the command signals received by the control unit may be sent from the transmitter to the receiving device.

### BACKGROUND OF THE INVENTION

1. Field of the Invention

The invention generally relates to a microphone. More particularly, the invention relates to a microphone with projector controller so as to allow a user to control the microphone and the projector so that a report may be presented more easily.

2. Description of the Prior Art

When a person gives out a report or speech in a meeting, he usually has to use a microphone so that the audience can hear and understand him. In addition, he may also use a projector and slides so as to allow the audience to have a better understanding of his report or speech.

In such case, such a person has to talk, hold a microphone and control the projector at the same time; also, a change of the slide often interrupts his speech and adversely affects the atmosphere of the meeting. Furthermore, such person may ask another person to change slides for him; however, chances are slides can not match the contents of his speech and this may confuse the audience.

With the advancement of the computer related technology and wireless technology, computer peripherals (such as keyboard and mouse) have become wireless via infrared radiation, the RF band or the Bluetooth band; hence, a person may use a wireless mouse or keyboard to control a computer so as to control a projector.

However, because a person often stands up while giving a report or speech and may walk around, the use of a wireless mouse or keyboard can interrupt his speech and adversely affect the atmosphere of the meeting.

To overcome such disadvantage, a wireless projector controlling device has been put on the market. Such device may replace a wireless mouse and allows a user to walk around on the stage.

However, the user has to hold a microphone with one hand and hold the device with another hand; this may cause stiffness in his two arms and can interrupt his speech and adversely affect the atmosphere of the meeting.

Though a microphone may be attached to a person's head or clothes by a clip, it can still distract him and can adversely affect his report or speech.

To eliminate the disadvantages of the prior art in the actual application, the inventor, who has a wealth of experience in the subject, has put in a lot of effort in the subject and has come up with the microphone with projector controller of the present invention.

### SUMMARY OF THE INVENTION

The object of the present invention is to provide a microphone with projector controller so as to allow a user to control the microphone and the projector so that a report may be presented more easily.

To reach the aforesaid object, the microphone of the present invention comprises a body, a processing unit, a sound collecting device, an analog-to-digital converter, a control unit and a transmitter. The processing unit is disposed inside the body. The sound collecting device is disposed at an appropriate location on the body so as to collect audio signals, which may then be converted to digital signals; the sound collecting device is connected with the processing unit. The analog-to-digital converter is disposed inside the body and connected with the processing unit so as to convert the signals sent to the processing unit. The control unit is disposed at an appropriate location on the body and is connected with the processing unit. The transmitter is connected with the processing unit.

The audio signals collected by the sound collecting device and the command signals received by the control unit may be sent from the transmitter to the receiving device.

### BRIEF DESCRIPTION OF THE DRAWINGS

The drawings disclose several illustrative embodiments of the present invention which serve to exemplify the various advantages and objects hereof, and are as follows:

FIG. 1 is a perspective view of the microphone of the present invention.

FIG. 2 is a block diagram schematically illustrating the operation framework for the microphone of the present invention.

FIG. 3 is a block diagram schematically illustrating the interactions between the microphone of the present invention and a corresponding receiving device.

FIG. 4 is a block diagram schematically illustrating a second embodiment of the present invention.

FIG. 5 is a block diagram schematically illustrating a third embodiment of the present invention.

FIG. 6 is a block diagram schematically illustrating a fourth embodiment of the present invention.

FIG. 7 is a block diagram schematically illustrating a fifth embodiment of the present invention.

### LIST OF REFERENCE NUMERALS

| | |
|---|---|
| 1 -- Body | 11 -- Battery set |
| 12 - Display panel | 2 -- Laser pointing device |
| 21 -- Laser head | 22 -- Activation switch |
| 3 -- Processing unit | 4 -- Sound collecting device |
| 5 -- Analog-to-digital converter | 6 -- Control unit |
| 61 -- Slide-changing buttons | 62 -- Track ball |
| 63 -- Control stick | 7 -- Transmitter |
| 8 -- Receiving device | 81 -- Notebook computer |
| 811 -- Receiver | 812 -- CPU |
| 82 -- Speaker | 83 -- Projector |

### DETAILED DESCRIPTION OF THE PREFERRED EMBODIMENT

To allow the patent examiners to have a better understanding of the structure, use and characteristics of the present invention, several preferred embodiments of the present invention will be elaborated with reference to the drawings in the following.

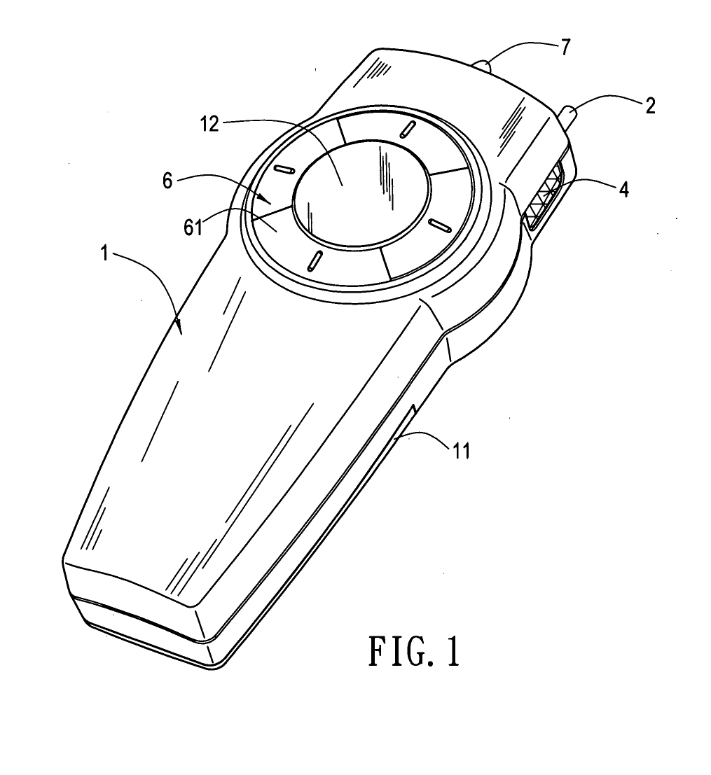

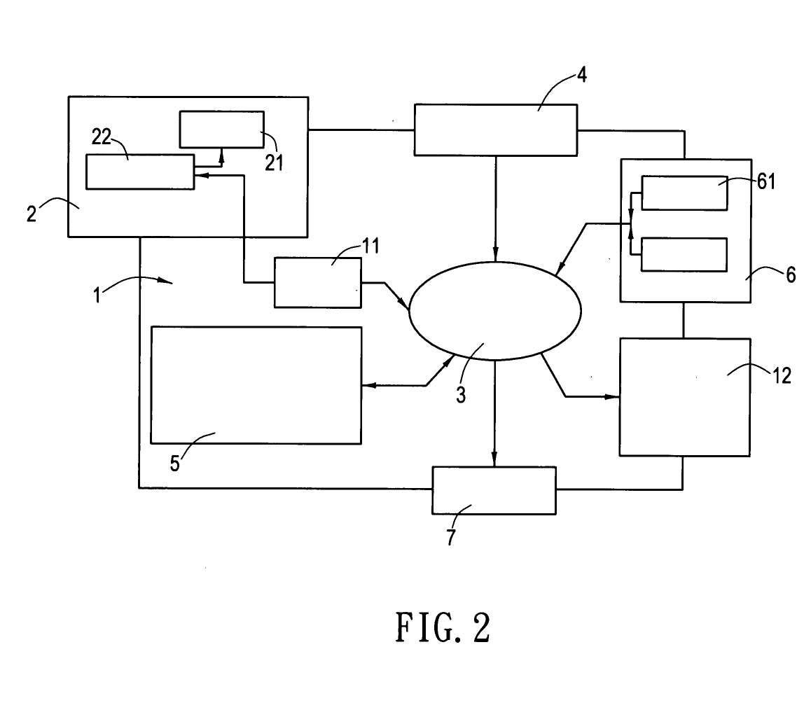

Referring to FIGS. 1 and 2, the microphone of the present invention comprises a body 1, a laser pointing device 2, a processing unit 3, a sound collecting device 4, an analog-to-digital converter 5, a control unit 6 and a transmitter 7.

The body 1 is substantially rectangular. A display panel 12 may be disposed at an appropriate location on the body 1. A battery set 11 is disposed inside the body 1 and may be a rechargeable battery set so as to supply power to the microphone.

The processing unit 3 is disposed inside the body 1.

The sound collecting device 4 is disposed at an appropriate location on the body 1 so as to collect audio signals, which may then be converted to digital signals. The sound collecting device 4 is connected with the processing unit 3.

The analog-to-digital converter 5 is disposed inside the body 1 and is connected with the processing unit 3 so as to convert the signals sent to the processing unit 3.

The control unit 6 is disposed at an appropriate location on the body 1 and is connected with the processing unit 3. A plurality of slide-changing buttons 61 are provided on the top surface of the control unit 6 so as to change slides.

The transmitter 7 is connected with the processing unit 3 and may transmit signals via infrared radiation.

A laser head 21 is disposed at an appropriate location on the body 1. An activation switch 22 is disposed on the body 1 and is connected with the laser head 21.

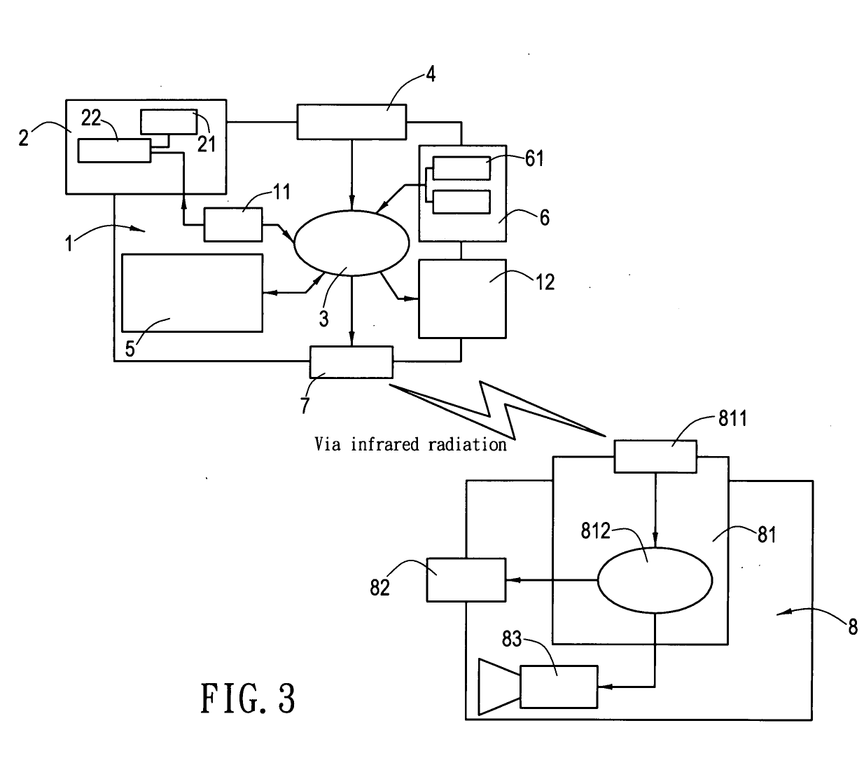

Referring to FIG. 3, a receiving device 8 which can receive the command signals sent out from the microphone of the present invention is shown. The receiving device 8 may be a notebook computer 81 connected with a speaker and a projector. The receiving device 8 includes at least a receiver 811, a CPU 812, a speaker 82 and a projector 83.

The notebook computer 81 includes the receiver 811 and the CPU 812. The receiver 811 can receive the audio signals and command signals sent from the transmitter 7. The CPU 812 is connected with the receiver 811 and may process the audio signals and command signals received by the receiver 811.

The speaker 82 is connected with the CPU 812 and can convert the audio signals received by the CPU 812 from the sound collecting device 4 into sounds.

The projector 83 is connected with the CPU 812 and can receive and execute the command signals received by the CPU 812 from the control unit 6.

As illustrated from FIG. 1 to 3, the sound collecting device 4 may collect the audio signals; the control unit 6 may receive command signals entered by a user; then, these audio signals and command signals may be sent from the transmitter 7 to the receiving device 8.

In use, when a meeting starts, a user may hold the body 1 of the microphone of the present invention while speaking to the audience. Now, the sounds sent from the user may be received by the sound collecting device 4 and these analog audio signals may then be sent to the processing unit 3; these analog audio signals are then converted into digital signals by the analog-to-digital converter 5 and are sent out from the transmitter 7 via infrared radiation to the receiver 811 of the receiving device 8. Next, the digital signals are sent to the CPU 812 and then to the speaker 82, and the speaker 82 converts the audio signals into sounds;

Also, the user may send out a command signal by pressing one of the slide-changing buttons 61 of the control unit 6. The command signal is sent to the processing unit 3 and is sent from the transmitter 7 via infrared radiation to the receiver 811 of the receiving device 8. Next, the command signal is passed on to the CPU 812, which tells the projector 83 to respond to the slide-changing command. In addition, the commands entered by the user and the data relating to the audio signals collected by the sound collecting device 4 may be shown on the display panel 12 so that the user may have a better control.

Furthermore, while a slide is shown on the projector, the user may turn on the activation switch 22 to activate the laser pointing device 2. Now, the user may use the laser pointing device 2 to point at various parts of the slide so that the audience may have a better understanding of the user's report or speech.

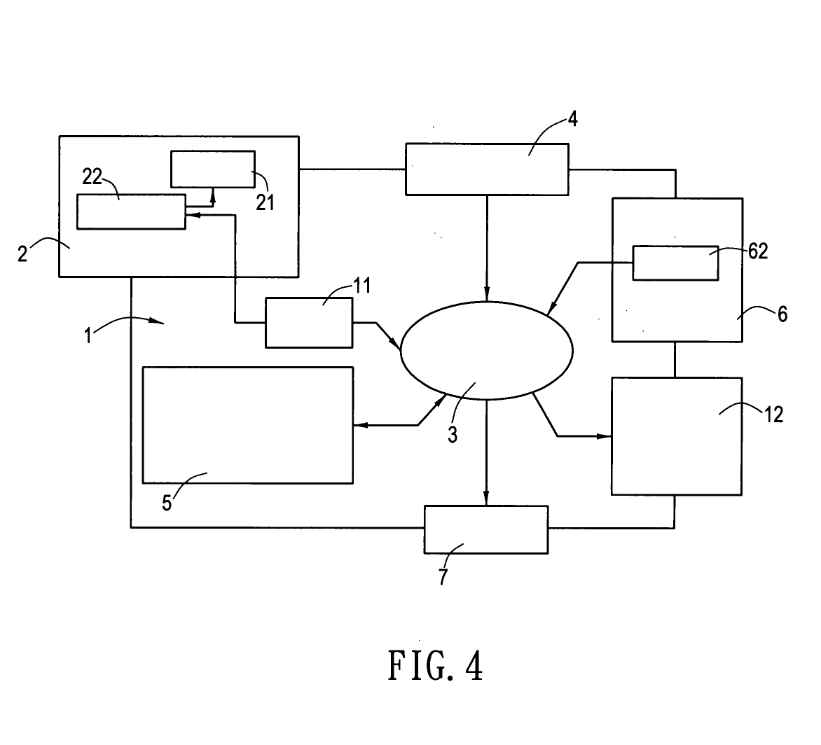

A second embodiment of the present invention is shown in FIG. 4. In the second embodiment, a track ball 62, instead of slide-changing buttons 61, is used to change slides. The track ball 62 is disposed on the body 1 of the microphone.

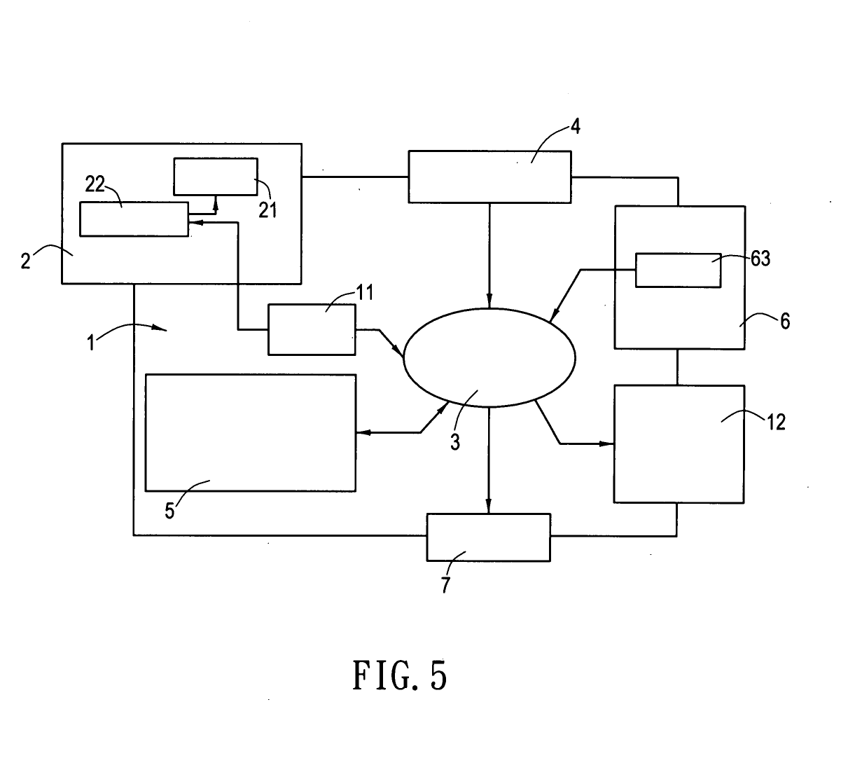

A third embodiment of the present invention is shown in FIG. 5. In the third embodiment, a control stick 63, instead of slide-changing buttons 61, is used to change slides. The control stick 63 is disposed on the body 1 of the microphone.

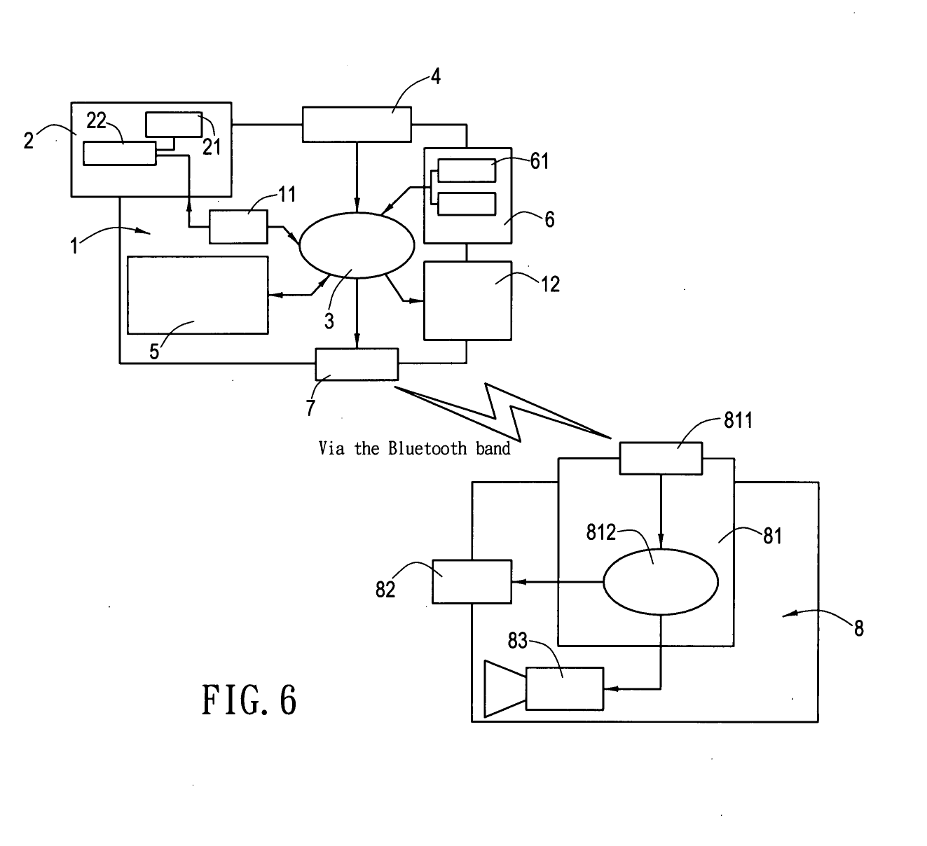

A fourth embodiment of the present invention is shown in FIG. 6. In the fourth embodiment, signals are sent from the transmitter 7 via the Bluetooth band to the receiver 811.

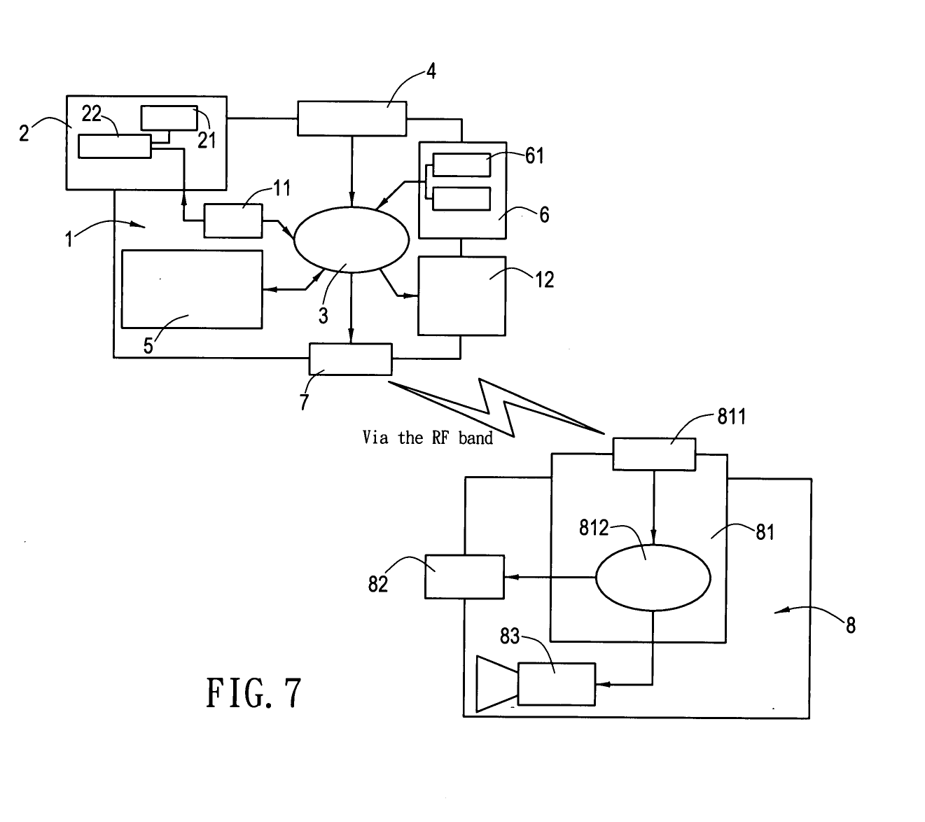

A fifth embodiment of the present invention is shown in FIG. 7. In the fourth embodiment, signals are sent from the transmitter 7 via the RF band to the receiver 811.

From the above, we can see that the microphone of the present invention has the following advantages:
1. A user may hold the microphone of the present invention with one hand. Also, the user may control the microphone functions and the projector functions simultaneously so that a report may be presented more easily.
2. While a slide is shown on the projector, the user may turn on the laser pointing device 2 to point at various parts of the slide so that the audience may have a better understanding of the user's report or speech.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A microphone with projector controller (working with a receiving device), comprising:
a body;
a processing unit, disposed inside the body;
a sound collecting device, disposed at an appropriate location on the body so as to collect audio signals, which may then be converted to digital signals, the sound collecting device being connected with the processing unit;
an analog-to-digital converter, disposed inside the body and connected with the processing unit so as to convert the signals sent to the processing unit;
a control unit, disposed at an appropriate location on the body and connected with the processing unit; and
a transmitter, connected with the processing unit, wherein the audio signals collected by the sound collecting device and the command signals received by the control unit may be sent from the transmitter to the receiving device.

2. The microphone as in claim 1, wherein a plurality of slide-changing buttons are provided on the top surface of the body so as to change slides.

3. The microphone as in claim 1, wherein a track ball, instead of the slide-changing buttons, is provided on the top surface of the body so as to change slides.

4. The microphone as in claim 1, wherein a control stick, instead of the slide-changing buttons, is provided on the top surface of the body so as to change slides.

5. The microphone as in claim 1, wherein a pointing device may be provided on the body of the microphone.

6. The microphone as in claim 5, wherein the pointing device may be a laser pointing device.

7. The microphone as in claim 6, wherein a laser head is disposed at an appropriate location on the body, and an activation switch is disposed on the body and is connected with the laser head.

8. The microphone as in claim 1, wherein the body may be substantially rectangular.

9. The microphone as in claim 1, wherein a power-supply unit may be disposed inside the body so as to supply power to the microphone.

10. The microphone as in claim 1, wherein the power-supply unit may be a battery set.

11. The microphone as in claim 10, wherein the battery set may be a rechargeable battery set.

12. The microphone as in claim 1, wherein a display panel may be disposed at an appropriate location on the body.

13. The microphone as in claim 1, wherein the receiving device at least includes:
a receiver, able to receive the audio signals and command signals sent from the transmitter;
a CPU, connected with the receiver so as to process the audio signals and command signals received by the receiver;
a speaker, connected with the CPU so as to convert the audio signals received by the CPU from the sound collecting device into sounds; and
a projector, connected with the CPU so as to receive and execute the command signals received by the CPU from the control unit.

14. The microphone as in claim 13, wherein signals are sent from the transmitter via infrared radiation to the receiver.

15. The microphone as in claim 13, wherein signals are sent from the transmitter via the RF band to the receiver.

16. The microphone as in claim 13, wherein signals are sent from the transmitter via the Bluetooth band to the receiver.
